(19) United States
(12) Patent Application Publication
(10) Pub. No.: US 2009/0185876 A1
(43) Pub. Date: Jul. 23, 2009

(54) GLASS WORKING APPARATUS AND GLASS WORKING METHOD USING THE SAME

(75) Inventor: Lu-Chia Liao, Taichung (TW)

Correspondence Address: BROWDY AND NEIMARK, P.L.L.C.;624 NINTH STREET, NW, SUITE 300, WASHINGTON, DC, 20001-5303, US

(73) Assignee: GRAIN ELECTRONICS, INC., Taichung City (TW)

(21) Appl. No.: 12/144,845

(22) Filed: Jun. 24, 2008

(30) Foreign Application Priority Data
Jan. 21, 2008 (TW) 97102237

(51) Int. Cl. B23B 47/34

(52) U.S. Cl. 408/17

(57) ABSTRACT

A glass working apparatus a casing, in which a rotating mechanism and an oscillating unit are installed. The rotating mechanism has a shaft rotatably mounted in the casing. The oscillating unit is connected with the shaft such that the oscillating unit is rotatable with the shaft. A glass cutting tool is connected to the oscillating unit, such that the glass cutting tool can be driven to rotate by the rotating mechanism through the oscillating unit and/or driven to oscillate by the oscillating unit for working on a glass workpiece.

### BACKGROUND OF THE INVENTION

1. Field of the Invention

The present invention relates generally to a glass working apparatus and more particularly, to a glass working apparatus that can process the workpiece efficiently. The present invention also concerns a glass working method adopting the aforesaid apparatus.

2. Description of the Related Art

In glass industry, the quality and efficiency of the glass panel processing are always needed to be concerned and improved. For processing a circular hole, a sand blasting device, mechanical drill or water knife may be used. However, the application of these conventional devices has some drawbacks on processing speed, cost, appearance or posterior process. For example, when a mechanical drill is used and rotated by a driving device to cut a glass workpiece, the periphery wall of the cutting hole tends to crack or, worstly, the whole glass workpiece may crack as the drill is lowered vertically to touch and drill the top surface of the glass workpiece. Therefore, the yield rate of this method is low.

To avoid cracking of the glass workpiece during corking, a two-step cutting method is usually employed. According to this two-step cutting method, a diamond drill that has a small round tip is used to drill a small circular recess on the workpiece at first, and then another diamond drill is used to drill and deepen the small circular recess to cut the workpiece to a depth approximately equal to one half of the thickness of the workpiece, and then a similar cutting procedure is performed to cut the workpiece from the bottom side for working out the desired hole eventually. Further, the structure of the drill must be close to perfect round, and there must be an interruption in the contact area of the drill so that cutting chips and waste powder can be expelled. Further, excessively high speed or low speed may result in a cutting failure.

The aforesaid two-step processing method provides certain improvement. However, because a glass panel is fragile, improper control of the contact pressure between the glass cutting tool and the glass workpiece may cause the glass workpiece to break or crack. Therefore, conventional glass working devices and methods cannot eliminate the problems of high defect rate and high processing cost.

Therefore, it is desirable to provide a glass working apparatus that eliminates the aforesaid problems.

### SUMMARY OF THE INVENTION

It is one objective of the present invention to provide a glass working apparatus, which will not cause the glass workpiece to crack easily, improving the yield rate.

It is another objective of the present invention to provide a glass working apparatus, which can simplify processing steps, shorten processing time, and reduce the processing cost.

To achieve these objectives, the glass working apparatus of the present invention comprises a casing, a rotating mechanism that has a shaft rotatably mounted in the casing, and an oscillating unit connected with the shaft and rotatable with the shaft.

When a glass cutting tool is connected to the oscillating unit and the rotating mechanism and the oscillating unit are started, the glass cutting tool can be rotated and oscillated simultaneously for cutting a glass workpiece efficiently without causing the glass workpiece to crack.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWING

The present invention will become more fully understood from the detailed description given herein below and the accompanying drawings which are given by way of illustration only, and thus are not limitative of the present invention, and wherein:

FIG. 1 is a schematically partially sectional view of a glass working apparatus according to a preferred embodiment of the present invention;

FIG. 2 is a schematic perspective drawing showing a drill removed from a glass workpiece after cut of a circular hole on the glass workpiece;

FIG. 3 is a schematic perspective drawing showing a cutting tool removed from the glass workpiece after cut of an oblong hole on the glass workpiece;

FIG. 4 is a schematic side view of a glass cutting tool in accordance with the preferred embodiment of the present invention;

FIG. 5 is a bottom view of the glass cutting tool in accordance with the preferred embodiment of the present invention;

FIG. 6 is a schematic drawing showing the hole-cutting portion of the glass cutting tool cut through a glass workpiece; and

FIG. 7 is a schematic drawing, showing that a chamfering portion of the glass cutting tool works on the circumference wall surrounding the through hole.

### DETAILED DESCRIPTION OF THE INVENTION

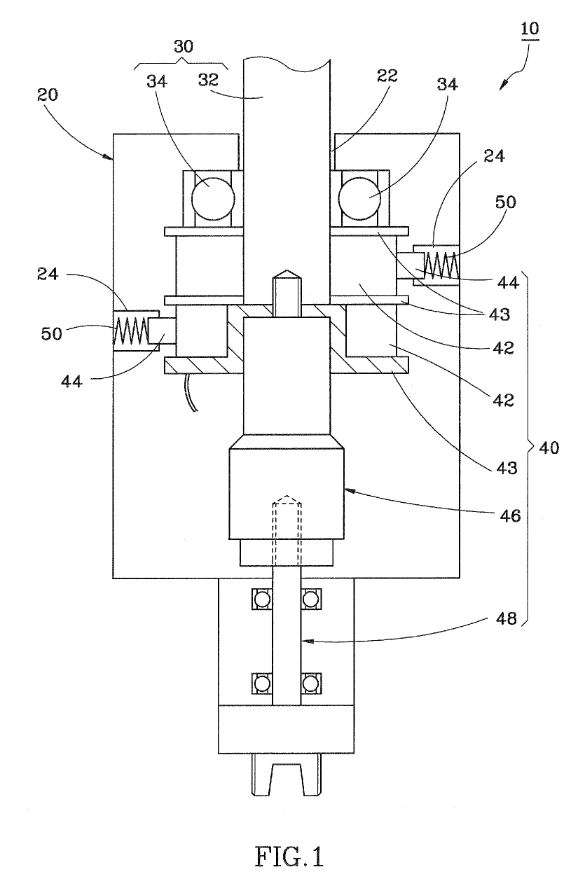

As shown in FIG. 1, a glass working apparatus 10 in accordance with a preferred embodiment of the present invention comprises a casing 20, a rotating mechanism 30, and an oscillating unit 40.

The casing 20 has an axle hole 22, and two receiving holes 24 extending from two opposite sides of the periphery toward the inside of the casing 20.

The rotating mechanism 30 comprises a plurality of axle bearings 34 mounted inside the casing 20 around the axle hole 22, and a shaft 32 inserted through into the axle hole 22 and supported in the axle bearings 34 for free rotation relative to the casing 20.

The oscillating unit 40 comprises two electrically conductive rings 42, three electrically insulative boards 43 made of Bakelite, two electrically conductive strips 44, an ultrasonic oscillator 46 and a connector 48. As shown in FIG. 1, the electrically conductive rings 42, the electrically insulative boards 43, the ultrasonic oscillator 46 and the connector 48 are fastened to the shaft 32 for synchronous rotation with the shaft 32. The two electrically conductive rings 42 are sleeved onto the shaft 32 and affixed thereto at different elevations and respectively electrically connected to the positive and negative poles (not shown) of the internal circuit of the oscillating unit 40. The three electrically insulative boards 43 are affixed to the shaft 32 and respectively set at the top and bottom sides relative to the electrically conductive rings 42 and in between the electrically conductive rings 42 to prevent a short circuit or accidental contact of external parts with the electrically conductive rings 42. The electrically conductive strip 44 are respectively mounted in the receiving holes 24 of the casing 20, and respectively forced by a respective spring member 50 into contact with the electrically conductive rings 42. An external power source is connectable to the electrically conductive rings 42 through the electrically conductive strips 44 to conduct the internal circuit of the oscillating unit 40, thereby driving the oscillating unit 40. According to the present preferred embodiment, the ultrasonic oscillator 46 oscillates at 40 KHz. The ultrasonic oscillator 46 is connected to the shaft 32 inside the casing 20 and electrically connected with the electrically conductive rings 42. When electrically connected, the ultrasonic oscillator 46 can generate ten or more thousand times of oscillation per second. The connector 48 is connected to the ultrasonic oscillator 46 and extends out of the casing 20 for the connection of a glass cutting tool.

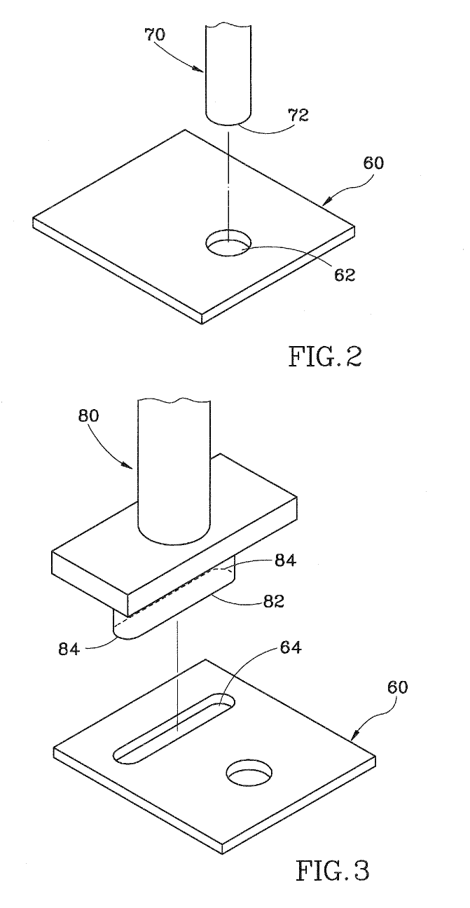

When the glass working apparatus 10 is used to cut a circular hole on a glass workpiece 60, a drill 70 is fixedly connected to the connector 48, and then the shaft 32 and the ultrasonic oscillator 46 are started, causing the drill 70 to be rotated and oscillated at a high speed. At this time, attach the circular bottom drilling tip 72 of the drill 70 to the surface of the glass workpiece 60, as shown in FIG. 2. Under the effects of rotation and oscillation of the drill 70, the circular bottom drilling tip 72 of the drill 70 cuts a circular hole 62 out of the glass workpiece 60. Under the effect of high speed oscillation, the drill and the glass workpiece produce an intermittent contact, thereby lowering rebound force of elastic deformation and friction force. In consequence, the invention relatively reduces radial force variation and avoids strain round. Further, lowering friction force relatively makes the cutting chips thinner, accelerates chip expelling speed and, reduces the speed difference between the expelling of cutting chips from center of the drill and the expelling of cutting chips from the periphery of the drill, i.e., the invention smoothens expelling of cutting chips and avoids cracking of the glass workpiece.

When the glass working apparatus 10 is used to cut an oblong hole on the glass workpiece 60, the drill 70 can be detached from the connector 48 and then another drill 80 can be fastened to the connector 48, as shown in FIG. 3. The drill 80 has an elongated bottom drilling tip 82. The elongated bottom drilling tip 82 has two smoothly arched chamfers 84 on the two distal ends of the periphery. When the ultrasonic oscillator 46 is started to oscillate the drill 80, attaching the drilling tip 82 of the drill 80 to the surface of the glass workpiece 60 will cut an oblong hole 64 on the glass workpiece 60.

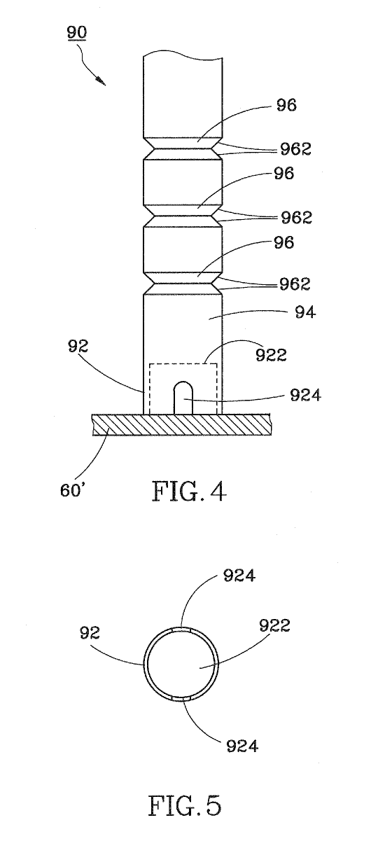

The aforesaid two drills are conventional glass cutting tools. To fully carry out the performance of the glass working apparatus 10, the invention provides a glass cutting tool 90. As shown in FIG. 4, the glass cutting tool 90 comprises a hole-cutting portion 92, a grinding portion 94, and three chamfering portions 96. The hole-cutting portion 92 is provided at the bottom portion of a body of the glass cutting tool 90 and has a circular cross section. The hole-cutting portion 92 has a recessed hole 922 recessed inwardly from the bottom end thereof, defining a circular open space, as shown in FIG. 5. The hole-cutting portion 30 further has two chip-conveying notches 924 disposed in communication with the recessed hole 922 at two opposite sides for expelling cutting chips of the workpiece out of the recessed hole 922. The grinding portion 94 is formed at a location above the top side of the hole-cutting portion 92 and has a smooth circumference periphery. The three chamfering portions 96 are spacedly formed above the top side of the grinding portion 94, and equally spaced one above another. Each chamfering portion 96 has two slope surfaces 962.

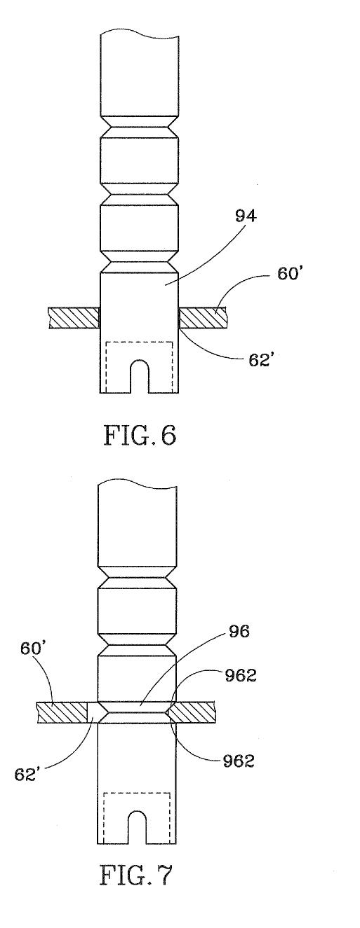

Referring to FIGS. 4-7 and FIG. 1 again, after installation of the glass cutting tool 90 in the glass working apparatus 10, the shaft 32 and the ultrasonic oscillator 46 can be started to rotate and oscillate the glass cutting tool 90 at a, high speed. At this time, the user can attach the hole-cutting portion 92 of the glass cutting tool 90 to the glass panel 60′, as shown in FIG. 4, for processing purpose. Because the hole-cutting portion 92 has the design of recessed hole 922, the contact area between the hole-cutting portion 90 and the glass panel 60′ is relatively smaller than the contact area between the hole-cutting portion of a similar conventional glass cutting tool and the glass workpiece. Therefore, the hole-cutting portion 92 can cut a circular hole 62′ on the glass panel 60′ at a speed quicker than the application of a conventional glass cutting tool (less workpiece cutting consumption) without causing the glass workpiece 60′ to crack (the glass workpiece receives less pressure). Further, cutting chips of the glass workpiece 60′ can be expelled to the outside through the chip-conveying notches 924 of the hole-cutting portion 92 rapidly during working. Thereafter, the glass cutting tool 90 can be lowered to grind the circumference wall that surrounds hole 62′ with the grinding portion 94, as shown in FIG. 6, thereby smoothening the circumference wall of the hole 62′. Thereafter, the glass cutting tool 90 can be further lowered to grind the circumference wall of the hole 62′ with the two slope surfaces 962 of one chamfering portion 96, processing the circumference wall of the hole 62′ into a chamfered edge, as shown in FIG. 7.

By means of the design of recessed hole, the invention effectively reduces the contact area between the hole-cutting portion of the glass cutting tool and the glass workpiece, avoiding cracking of the glass workpiece during working and lowering the defect rate and processing cost. Further, the glass cutting tool of the present invention has a grinding portion and multiple chamfering portions. Therefore, one single glass cutting tool can be used to achieve different processing works, saving much labor and time. In consequence, the processing cost is greatly reduced.

As stated above, the invention utilizes high speed rotation of the rotating mechanism and high frequency oscillation of the oscillating unit to match with a specially designed glass cutting tool, enabling the glass workpiece to be rapidly cut subject to the desired shape without cracking. Therefore, the invention greatly improves product yield rate and facilitates processing.

Further, the invention can be used to process a metal workpiece subject to the use of a diamond cutting tool of precision 0.0005 mm to match with high frequency oscillation of the ultrasonic oscillator so as to polish and trim the metal workpiece.

Further, the oscillation frequency of the ultrasonic oscillator is not limited to 40 KHz. An ultrasonic oscillator that oscillates at 28 KHz can be used as a substitute. The oscillation frequency of the ultrasonic oscillator is determined subject to the user's requirements.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A glass working apparatus comprising:
a casing;
a rotating mechanism having a shaft rotatably mounted in said casing; and
an oscillating unit connected with said shaft and rotatable with said shaft.

2. The glass working apparatus as claimed in claim 1, wherein said rotating mechanism comprises at least one axle bearing mounted inside said casing to support said shaft.

3. The glass working apparatus as claimed in claim 1, wherein said oscillating unit comprises three electrically insulative boards spacedly mounted inside said casing at different elevations two electrically conductive rings sleeved onto said shaft and respectively located between two adjacent said electrically insulative boards, two electrically conductive strips respectively electrically kept in contact with said electrically conductive rings, and an ultrasonic oscillator electrically connected to said electrically conductive rings.

4. The glass working apparatus as claimed in claim 3, wherein said casing has two receiving holes for receiving said electrically conductive strips respectively.

5. A glass cutting tool for use in cooperation with the glass working apparatus of claim 1, said glass cutting tool comprising an elongated hole-cutting portion at a bottom thereof.

6. The glass cutting tool as claimed in claim 5, wherein said elongated hole-cutting portion has two chamfers at two distal ends thereof.

7. A glass cutting tool for use in cooperation with the glass working apparatus of claim 1, said glass cutting tool comprising a body having a hole-cutting portion at a bottom portion thereof, wherein the hole-cutting portion has a circular cross section and a recessed hole recessed inwardly from a bottom end thereof.

8. The glass cutting tool as claimed in claim 7, wherein said body further comprises a grinding portion located above said hole-cutting portion and having a smooth circumference periphery.

9. The glass cutting tool as claimed in claim 8, wherein said body further comprises at least one chamfering portion located above said grinding portion.

10. The glass cutting tool as claimed in claim 9, wherein said at least one chamfering portion has two slope surfaces.

11. The glass cutting tool as claimed in claim 9, wherein said body comprises a plurality of said chamfering portions spaced from one another.

12. The glass cutting tool as claimed in claim 7, wherein said hole-cutting portion has at least one chip-conveying in communication with said recessed hole.

13. The glass cutting tool as claimed in claim 12, wherein said hole-cutting portion comprises two said chip-conveying notches, which are disposed at two opposite sides relative to said recessed hole.

14. A glass working method comprising the steps of:
a) providing a glass working apparatus having a rotating mechanism and an oscillating unit connected with said rotating mechanism and rotatable with said rotating mechanism; and
b) connecting a glass cutting tool to said oscillating unit such that said cutting tool can be driven to rotate by said rotating mechanism through said oscillating unit and/or driven to oscillate by said oscillating unit for cutting a glass workpiece.

15. The glass working method as claimed in claim 14, wherein said rotating mechanism comprises a shaft connected with said oscillating unit.

16. The glass processing method as claimed in claim 15, said oscillating unit comprises three electrically insulative boards, two electrically conductive rings sleeved onto said shaft and respectively located between two adjacent said electrically insulative boards, two electrically conductive strips respectively electrically kept in contact with said electrically conductive rings, and an ultrasonic oscillator electrically connected to said electrically conductive rings.
